(19) United States
(12) Patent Application Publication
(10) Pub. No.: US 2014/0091025 A1
(43) Pub. Date: Apr. 3, 2014

(54) SLUDGE-SOLIDIFYING SYSTEM

(71) Applicant: Xia Wen, Shen Zhen (CN)

(72) Inventor: Xia Wen, Shen Zhen (CN)

(21) Appl. No.: 13/633,147

(22) Filed: Oct. 2, 2012

(51) Int. Cl. C02F 11/14

(52) U.S. Cl. 210/219

(57) ABSTRACT

The present invention provides a sludge-solidifying system, which comprises a mechanical operator and a mixing and solidifying device. The mixing and solidifying device comprises a rack unit, an actuating unit, a mixing unit and a curing-agent spraying unit for controlling to spraying curing agent. The sludge-solidifying system of the present invention has a high process speed for processing the sludge.

### FIELD OF THE INVENTION

The present invention relates to a sludge-processing device and an operation method thereof, and more particularly to a sludge-solidifying system.

### BACKGROUND OF THE INVENTION

In the water conservancy project and the water-environment treating project, a large of sludge is generated, and the sludge will occupy a great of land. Because the city-construction land and the industrial and agricultural land are less, the land expropriation problem has been an important bottleneck for limiting the water conservancy project and the water-environment treating project.

In the process for processing the sludge, a method is solidifying the sludge. However, the conventional sludge-solidifying system should process the sludge only after performing the moving operation for the sludge, thus the sludge-processing speed of the sludge-solidifying system is slower, and the equipment cost thereof is higher.

### SUMMARY OF THE INVENTION

The present invention relates to a sludge-solidifying system, which has a high process speed for processing sludge.

The present invention provides a sludge-solidifying system, which comprises a mechanical operator and a mixing and solidifying device. The mixing and solidifying device comprises a rack unit, an actuating unit, a mixing unit and a curing-agent spraying unit for controlling to spray curing agent. The rack unit has a first terminal and a second terminal opposite to the first terminal. The first terminal is fixed on the mechanical operator. The actuating unit is arranged in the rack unit. The mixing unit has a first impeller, a second impeller and a third impeller. The first impeller, the second impeller and the third impeller are connected to the actuating unit. The first impeller and the second impeller are arranged at two opposite sides of the rack unit, and the third impeller is arranged on the second terminal of the rack unit. The curing-agent spraying unit comprises a storage tank and nozzles connected to the storage tank. The nozzles are arranged on the rack unit and adjacent to the first impeller and the second impeller.

The sludge-solidifying system may directly solidify the sludge, thus it can easily improve the sludge-processing speed thereof. Furthermore, the mixing and solidifying device may be fixed on the mechanical operator, thus the production cost thereof is lower. In addition, the mixing and solidifying device may combine the mixing function and the solidifying function, thus it is agile in use and the operation thereof is convenient.

### BRIEF DESCRIPTION OF THE DRAWINGS

The present invention will become more readily apparent to those ordinarily skilled in the art after reviewing the following detailed description and accompanying drawings, in which:

FIG. 1 is a block view of a mixing and solidifying device of a sludge-solidifying system in accordance with an exemplary embodiment of the present invention.

FIG. 2 is a structure schematic view of the mixing and solidifying device as shown in FIG. 1.

FIG. 3 is a structure schematic view of a mixing and solidifying device in accordance with another exemplary embodiment of the present invention.

### DETAILED DESCRIPTION OF PREFERRED EMBODIMENTS

The present invention will now be described more specifically with reference to the following embodiments. It is to be noted that the following descriptions of preferred embodiments of this invention are presented herein for purpose of illustration and description only. It is not intended to be exhaustive or to be limited to the precise form disclosed.

The following will cooperate figures and embodiments to further describe a sludge-solidifying system of the present disclosure in detail.

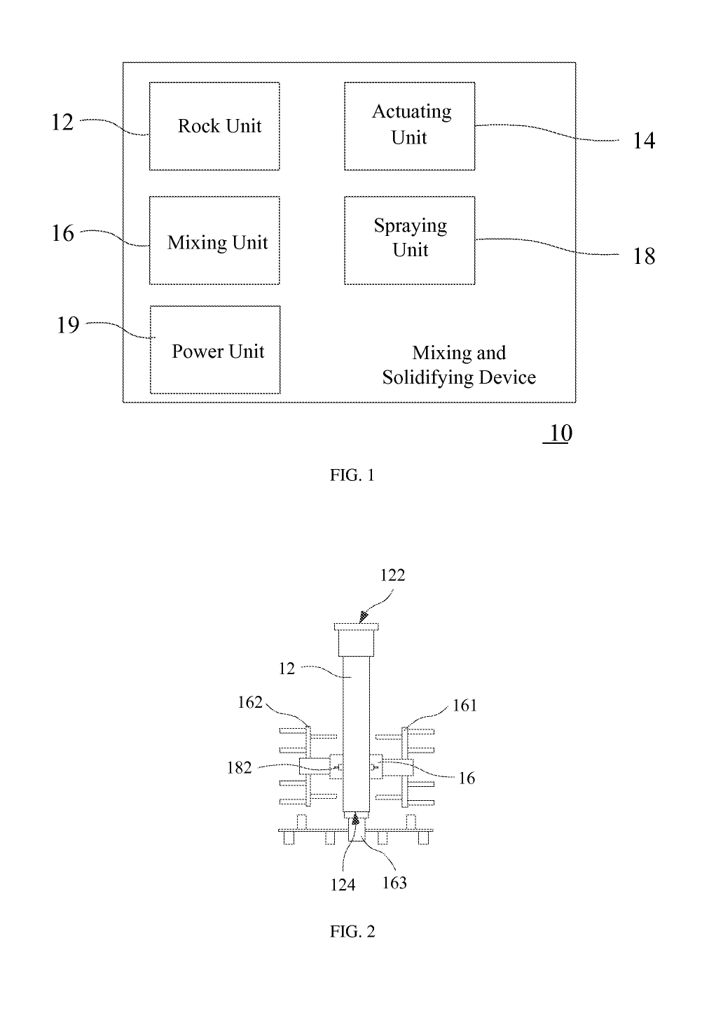

Referring to FIGS. 1 and 2, a sludge-solidifying system of an exemplary embodiment of the present invention comprises a mechanical operator (not shown) and a mixing and solidifying device 10. The mixing and solidifying device 10 comprises a rack unit 12, an actuating unit 14, a mixing unit 16 and a curing-agent spraying unit 18 for controlling the spray of the curing agent. The rack unit 12 has a first terminal 122 and a second terminal 124 opposite to the first terminal 122. The first terminal 122 is configured for fixing with the mechanical operator, such as to fix the mixing and solidifying device 10 on the mechanical operator. The actuating unit 14 is arranged in the rack unit 12. The mixing unit 16 has a first impeller 161, a second impeller 162 and a third impeller 163. The first impeller 161, the second impeller 162 and the third impeller 163 are connected to the actuating unit 14, such that the actuating unit 14 may drive the first impeller 161, the second impeller 162 and the third impeller 163 to rotate. The first impeller 161 and the second impeller 162 are arranged at two opposite sides of the rack unit 12 respectively, and the third impeller 163 is arranged on the second terminal 124 of the rack unit 12. The curing-agent spraying unit 18 comprises a storage tank (not shown) and two nozzles 182 connected to the storage tank. Furthermore, the two nozzles 182 are arranged on the rack unit 12 and adjacent to the first impeller 161 and the second impeller 162 respectively.

In the exemplary embodiment, the mechanical operator may be an excavator, and the excavator may have a digging arm. The first terminal 122 of the rack unit 12 may be fixed on the digging arm, and the storage tank also may be fixed on the excavator. The storage tank and the nozzles 182 may be connected via pipelines, such that the curing agent in the storage tank may be sprayed from the nozzles 182 by a driving element in the storage tank, such as a hydraulic press. It can be understood that, the mechanical operator of the present invention is not limited in the excavator, for example, it also may be a motor vehicle. In additional, it can be understood that, the storage tank also may be fixed on the rack unit 12.

The mixing and solidifying device 10 may further comprises a power unit 19. The power unit 19 is arranged in the rack unit 12 and is connected to the actuating unit 14 for providing the power to the actuating unit 14, such that the first impeller 161, the second impeller 162 and the third impeller 163 of the mixing unit 16 are driven to rotate. However, the present invention is not limited herein. In another exemplary embodiment, the mixing unit 16 may be provided the power by a power element of the mechanical operator, that is, the actuating unit 14 may be designed to be connected to the power element of the mechanical operator.

The sludge-solidifying system can directly solidify the sludge, thus it can easily improve the sludge-processing speed thereof. Furthermore, the mixing and solidifying device may be fixedly installed on the mechanical operator, thus the production cost thereof is lower. In additional, the mixing and solidifying device may combine the mixing function and the solidifying function, thus it is agile in use and the operation is convenient. For example, when the mechanical operator is the excavator, the mixing and solidifying device may be fixed on the digging arm to use the original controlling system of the excavator to control the deep and the direction of the mixing operation performed by the mixing and solidifying device. Specially, the first impeller 161 and the second impeller 162 of the sludge-solidifying system are arranged at two opposite sides of the rack unit 12, and the third impeller 163 is arranged on the second terminal 124 of the rack unit 12, thus after the first impeller 161 and the second impeller 162 mix the sludge which is sprayed with the curing agent, the third impeller 163 may further uniformly mix the mixed sludge. Therefore, it is advantageous to uniformly solidify the sludge, and improve the using effect of the sludge-solidifying system.

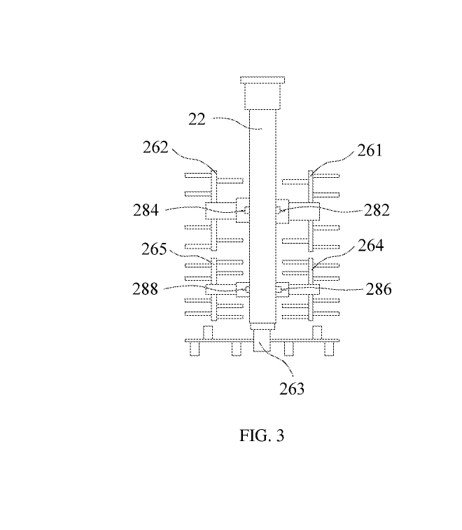

Refer to FIG. 3, which is a structure schematic view of a mixing and solidifying device of the sludge-solidifying system in accordance with another exemplary embodiment of the present invention. The mixing and solidifying device of the exemplary embodiment is similar with the above mixing and solidifying device 10, expect that the mixing and solidifying device of the exemplary embodiment comprises a first impeller 261, a second impeller 262, a third impeller 263, a fourth impeller 264 and a fifth impeller 265, and a spraying unit 28 comprises a first nozzle 282, a second nozzle 284, a third nozzle 286 and a fourth nozzle 288. The structure of the first impeller 261 is same to that of the second impeller 262, and the structure of the fourth impeller 264 is same to that of the fifth impeller 265. The first impeller 261 and the fourth impeller 264 are arranged at a side of a rack unit 22, and the second impeller 262 and the fifth impeller 265 are arranged at an opposite side of the rack unit 22. In addition, the fourth impeller 264 is arranged between the first impeller 261 and the third impeller 263, and the fifth impeller 265 is arranged between the second impeller 262 and the third impeller 263. Specially, each of the first impeller 261, the second impeller 262, the third impeller 263, the fourth impeller 264 and the fifth impeller 265 has a plurality of mixing teeth, the size of the mixing teeth of the fourth impeller 264 and the fifth impeller 265 are smaller than that of the mixing teeth of the first impeller 261 and the second impeller 262, and the amount of the mixing teeth of the fourth impeller 264 and the fifth impeller 265 is larger than that of the mixing teeth of the first impeller 261 and the second impeller 262.

The first nozzle 282, the second nozzle 284, the third nozzle 286, and the fourth nozzle 288 are located corresponding to the first impeller 261, the second impeller 262, the fourth impeller 264 and the fifth impeller 265 respectively. Each of the first nozzle 282, the second nozzle 284, the third nozzle 286 and the fourth nozzle 288, may have a flow-controlling element (not shown) arranged thereon, such as to control the spraying rate of each nozzle spraying the curing agent. For example, the exemplary embodiment may use flow-controlling elements to make the spraying rates of the first nozzle 282 and the second nozzle 284 spraying the curing agent larger, and make the spraying rates of the third nozzle 286 and the fourth nozzle 288 spraying the curing agent smaller.

In use, the mixing and solidifying device comprises the fourth impeller 264 and the fifth impeller 265, and comprises more nozzles, thus it may easily mixing the curing agent into the sludge more uniformly, such that the sludge is solidified more uniformly.

In addition, to make the sludge-solidifying system more convenient in use, the mixing and solidifying device may further comprise a cleaning element arranged on the spraying unit, and the cleaning element may be connected to the storage tank. When the mixing and solidifying device should be cleaned, it may insert cleaning fluid (such as pure water) into the storage tank, and then use the cleaning element to perform the self-cleaning operation for the mixing and solidifying device. Therefore, it is advantageous to store and use the mixing and solidifying device.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A sludge-solidifying system, comprising:
a mechanical operator; and
a mixing and solidifying device, comprising:
a rack unit, having a first terminal and a second terminal opposite to the first terminal, wherein the first terminal is fixed on the mechanical operator;
an actuating unit, arranged in the rack unit;
a mixing unit, having a first impeller, a second impeller and a third impeller, wherein the first impeller, the second impeller and the third impeller are connected to the actuating unit, the first impeller and the second impeller are arranged at two opposite sides of the rack unit respectively, and the third impeller is arranged on the second terminal of the rack unit;
a curing-agent spraying unit, configured for controlling to spray curing agent, wherein the curing-agent spraying unit comprises a storage tank and nozzles connected to the storage tank, the nozzles are arranged on the rack unit and adjacent to the first impeller and the second impeller.

2. The sludge-solidifying system according to claim 1, wherein the mixing and solidifying device further comprises a power unit, and the power unit is arranged in the rack unit and connected to the actuating unit.

3. The sludge-solidifying system according to claim 1, wherein the actuating unit of the mixing and solidifying device is connected to a power element of the mechanical operator.

4. The sludge-solidifying system according to claim 1, wherein the mixing and solidifying device further comprises a fourth impeller and a fifth impeller, the fourth impeller and the fifth impeller are arrange at the two opposite sides of the rack unit respectively, the fourth impeller is arranged between the first impeller and the third impeller, and the fifth impeller is arrange between the second impeller and the third impeller.

5. The sludge-solidifying system according to claim 4, wherein the first impeller is same to the second impeller in structure, and the fourth impeller is same to the fifth impeller in structure.

6. The sludge-solidifying system according to claim 5, wherein each of the first impeller, the second impeller, the fourth impeller, and the fifth impeller, has a plurality of mixing teeth formed thereon, the size of the mixing teeth of the fourth impeller and the fifth impeller is smaller than that of the mixing teeth of the first impeller and the second impeller, and the amount of the mixing teeth of the fourth impeller and the fifth impeller is larger than that of the mixing teeth of the first impeller and the second impeller.

7. The sludge-solidifying system according to claim 4, wherein the nozzles comprises a first nozzle, a second nozzle, a third nozzle and a fourth nozzle, each of the first nozzle, the second nozzle, the third nozzle and the fourth nozzle has a flow-controlling element arranged thereon, and the first nozzle, the second nozzle, the third nozzle and the fourth nozzle is located corresponding to the first impeller, the second impeller, the fourth impeller and the fifth impeller.

8. The sludge-solidifying system according to claim 1, wherein the mechanical operator is an excavator, the excavator has a digging arm, and the first terminal of the rack unit is fixed on the digging arm.

9. The sludge-solidifying system according to claim 8, wherein the storage tank is fixed on the excavator, and the storage tank is connected to the nozzles via pipelines.
